(19) United States
(12) Patent Application Publication
(10) Pub. No.: US 2012/0030102 A1
(43) Pub. Date: Feb. 2, 2012

(54) FACILITATING A NETWORK COMMUNICATION SERVICE FOR A SUBSCRIBER LINKED TO A PLURALITY OF ACCOUNTS

(75) Inventors: Christopher Allen Doehler, Lone Tree, CO (US); Lior Auslander, Voorhees, NJ (US); Geoffrey Benger Coleman, Voorhees, NJ (US); Bruce Frankel, Marlton, NJ (US); Gabriel Matsliach, Voorhees, NJ (US); David M. Sell, Howell, NJ (US); Paresh C. Shah, Mt. Laurel, NJ (US); Pankaj Trivedi, Voorhees, NJ (US)

(73) Assignee: Comverse, Inc.

(21) Appl. No.: 13/262,967

(22) PCT Filed: Apr. 30, 2009
(86) PCT No.: PCT/US09/02647

§ 371 Date: Oct. 5, 2011

(51) Int. Cl. G06Q 20/22; G06Q 20/14

(52) U.S. Cl. 705/40; 705/39

(57) ABSTRACT

There is provided a method that includes (a) receiving a notification of an event concerning a network communication service involving a subscriber, in which the subscriber is linked to a first account having first account terms, and a second account having second account terms, (b) making a decision of whether to handle the network communication service in accordance with the subscriber being linked to the first account or in accordance with the subscriber being linked to the second account, and (c) issuing a communication to a device to facilitate the network communication service, pursuant to the decision. There is also provided a system that performs the method, and a storage medium that contains instructions for controlling a processor to perform the method.

### BACKGROUND OF THE INVENTION

1. Field of the Invention

The present invention relates to a facilitation of a network communication service, and more particularly, in a situation where a subscriber is linked to a plurality of accounts, and thus, a charge for the network communication service may be levied in accordance with one of a plurality of pricing plans.

2. Description of the Related Art

An individual consumer of network services, for example, a mobile phone subscriber, is challenged by two contrasting positions. On the one hand, the person desires a single device with which to communicate to the rest of the world. On the other hand, the person has different roles to play in life, and at least some of those roles might represent an alternative financial arrangement between the person and a third party. Any given call or content download or other chargeable event could be associated with any one of those roles.

The person has a choice to make. The person could opt to carry multiple devices, one for each role that is played, such that the financial implications of the chargeable events are neatly apportioned to the appropriate paying parties. This nicely handles the financial aspects, but leaves the person carrying around multiple phones. Alternatively, the person could opt to simply carry a single phone, accept all financial liability for all events, and then arrange for compensation from relevant third parties after the fact. This allows for the person to carry a single phone, but places a heavy burden of financial reconciliation on the person.

### SUMMARY OF THE INVENTION

There is provided a method that includes (a) receiving a notification of an event concerning a network communication service involving a subscriber, in which the subscriber is linked to a first account having first account terms, and a second account having second account terms, (b) making a decision of whether to handle the network communication service in accordance with the subscriber being linked to the first account or in accordance with the subscriber being linked to the second account, and (c) issuing a communication to a device to facilitate the network communication service, pursuant to the decision. There is also provided a system that performs the method, and a storage medium that contains instructions for controlling a processor to perform the method.

### BRIEF DESCRIPTION OF THE DRAWINGS

FIG. 1 is an illustration of a configuration of accounts for services provided by a service provider.

FIG. 2 is a block diagram of a communication system that enables provision of a service for a subscriber that is linked to a plurality of accounts.

FIG. 3 is a flowchart of a pre-authorization process for a network communication service.

### DESCRIPTION OF THE INVENTION

An event is a chargeable activity in a communication network. The technique disclosed herein is presented in the context of an event involving a mobile telephone service subscriber attempting to make a call with a cell phone. However, there is nothing intrinsic to this technique that imposes a limitation to a mobile telephone service. The technique is equally applicable to a person attempting to order a pay-per-view movie from a cable set top box, a person attempting to download online content, or any other scenario in which network actions are converted into ratable events that are charged to some liable party.

The present description introduces a concept referred to herein as a “shadow subscriber.” A shadow subscriber is a subscriber to a service for which certain charge liabilities are redirected from one account to another. The shadow subscriber is liable for those redirected charges. For example, if an employee must pay for calls outside of business hours, then charges for calls made after work can be redirected to a personal account.

At the end of the present description, there is a table, namely Table 1, that contains definitions of some other terms.

The shadow subscriber feature allows a single end-user, i.e., the “real” subscriber, to exist in an environment where the financial liability for any given call or event can be redirected to one or more other liable accounts. Shadow subscribers are created in the context of the account that is accepting liability, to insure that the liable party is indeed accepting financial responsibility for the charges that may be redirected to it. Shadow subscribers benefit from all the features and flexibilities that a normal subscriber record does.

The redirection to a shadow subscriber either can be determined based on evaluation of configured rules, or can alternatively be manually overridden to redirect unconditionally to a specific shadow subscriber.

When events are redirected to a shadow subscriber, they are rated and charged in the context of the pricing plans and balances of the shadow subscriber, regardless of what plans and balances the real subscriber might have. The amount of financial liability that the account which owns the shadow subscriber is willing to undertake can be limited on a cyclical, i.e. in alignment with monthly billing cycle, basis or be left unlimited.

All of these evaluations happen in real-time, as a part of call pre-authorization.

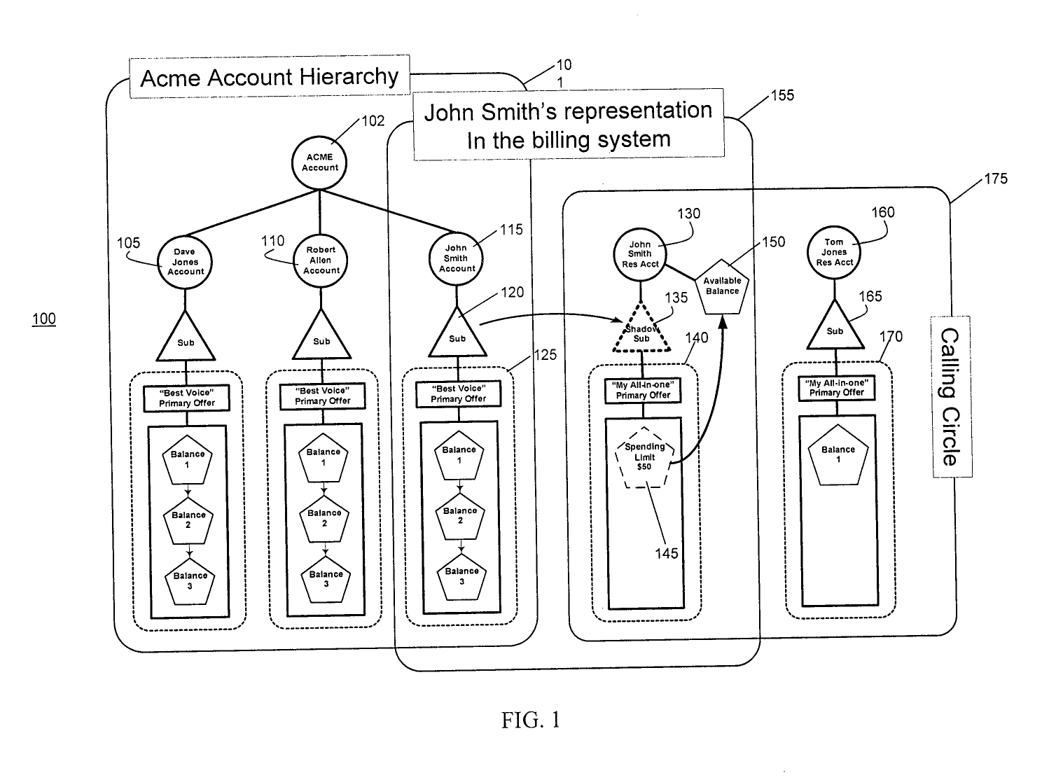

FIG. 1 is an illustration of a configuration of accounts, i.e., configuration 100, for services provided by a service provider. Configuration 100 includes an Acme account hierarchy 101, with a corporate-level account 102, which in turn has sub-accounts 105, 110 and 115.

Account 102 is a corporate-level account for Acme, Inc. John is an employee of Acme, Inc. Sub-account 115 presents billing for John's phone. A subscriber 120 represents John's phone as a delivery point for services, and the “Best Voice” offer, i.e., a pricing plan 125, defines pricing plans for the products and services John receives. Each of sub-accounts 105 and 110 also has a subscriber and a pricing plan for products and services.

Acme won't pay for personal use calls, and pricing plan 125 doesn't even allow data services. Acme will, however, allow John to pay for personal use and data services himself. So, John calls the service provider to set up an alternative billing relationship via liability redirection to a shadow subscriber 135. In this scenario, John as an individual becomes the liable party represented by an account 130. Shadow subscriber 135 is set up to receive liability redirection from subscriber 120. Shadow subscriber 135 has its own “My all-in-one” pricing plan, i.e., a pricing plan 140, that allows for both voice calls and data services. John wants to limit his personal spending to $50/month, so he establishes a spending limit 145 of $50/month that consumes an available balance 150 on account 130. Available balance 150 represents real money that is actually used to pay for the data services.

With John's account, i.e., account 130, shadow subscriber 135 and pricing plan 140 in place, John can now consume data services and have personal calls charged to him. John Smith the person, designated by reference numeral 155, is represented in the billing system by both Acme sub-account 115 and its subordinate entities, and by account 130 and its subordinate entities.

A system that processes the call will initially guide the call to subscriber 120, and redirection rules will be evaluated to determine whether charges should be redirected to shadow subscriber 135. In this particular case, the redirection rules would indicate (a) that any type of data service, occurring at any point in time, should be redirected to shadow subscriber 135, and (b) that any voice call made outside of business hours should also be redirected to shadow subscriber 135. The amount that will be charged for the call, i.e., its rated amount, will be computed based on John's personal pricing plan, i.e., pricing plan 140, rather than his Acme pricing plan, i.e., pricing plan 125. The charge for the call will count against spending limit 145, and if spending limit 145 is exceed, then the call will revert back to subscriber 120 for further processing. If there is available funding on spending limit 145, then there still must be funds in available balance 150 to cover the charges. Spending limit 145 simply restricts the amount of funds that shadow subscriber 135 is allowed to consume, but is in-and-of-itself no guarantee that John's personal account, i.e., account 130, actually has funds to pay for the network event; that can only be assured by examining available balance 150, and therefore both must be consulted. If there is either (a) insufficient funding on spending limit 145 to cover the charges OR (b) insufficient funds in available balance 150 to cover the charges, then again processing of the call reverts back to subscriber 120. If, on the other hand, if there is (a) available funding on spending limit 145 to cover the charges AND (b) funds in available balance 150 to cover the charges, then a rated amount for the call is counted against spending limit 145 and deducted from available balance 150 and the call is authorized.

John 155 is a member of a calling circle 175 that includes Tom Jones 160. A subscriber 165 represents a phone as a delivery point for services for Tom Jones 160, pursuant to a pricing plan 170. Shadow subscriber 135 can participate in calling circle 175 independently from any calling circle memberships of its associated real subscriber, i.e., subscriber 120. For cases where the call is made by John 155 to Tom Jones 160, i.e., another member of calling circle 175, if the call is redirected to shadow subscriber 135, calling circle benefits are conferred. But for cases where John 155 makes a call and it is NOT redirected, but rather, is processed in the context of subscriber 120, calling circle benefits are NOT conferred. For cases where a call is made to John 155 by Tom Jones 160, the sum of all calling circle memberships across John 155's entire representation in the system, in this case shadow subscriber 135 and subscriber 125, are considered in determining if calling circle benefits should be conferred. In this specific case, because shadow subscriber 135 is a member of the same calling circle as subscriber 165, calling circle benefits are conferred.

In cases like the corporate example of FIG. 1, imagine that the subscriber roles were reversed for John, that the real subscriber was under his individual account 130, call this real subscriber A, and the shadow subscriber was under account 115 in the Acme hierarchy of account 102, we'll call this shadow subscriber B.

If Acme account hierarchy 101 had an intra-hierarchy discounting plan set up, which gives special pricing considerations for calls between subscribers that are in Acme account hierarchy 101, then shadow subscriber B would be able to take part in that as well. That is, if John 155 placed a call that was redirected to shadow subscriber B, and it was made to a subscriber under one of John's co-worker's sub-accounts 105 or 110, that would be considered an intra-hierarchy call and discounted as such. If, on the other hand, the call was not redirected, and was instead rated and charged in the context of John's personal account, i.e., account 130, and real subscriber A, it would not be considered an intra-hierarchy call, and as such no special intra-hierarchy discounting would apply. Any other Acme employee making calls to John 155 will receive intra hierarchy pricing considerations, because John 155 has an associated shadow subscriber B in Acme account hierarchy 101.

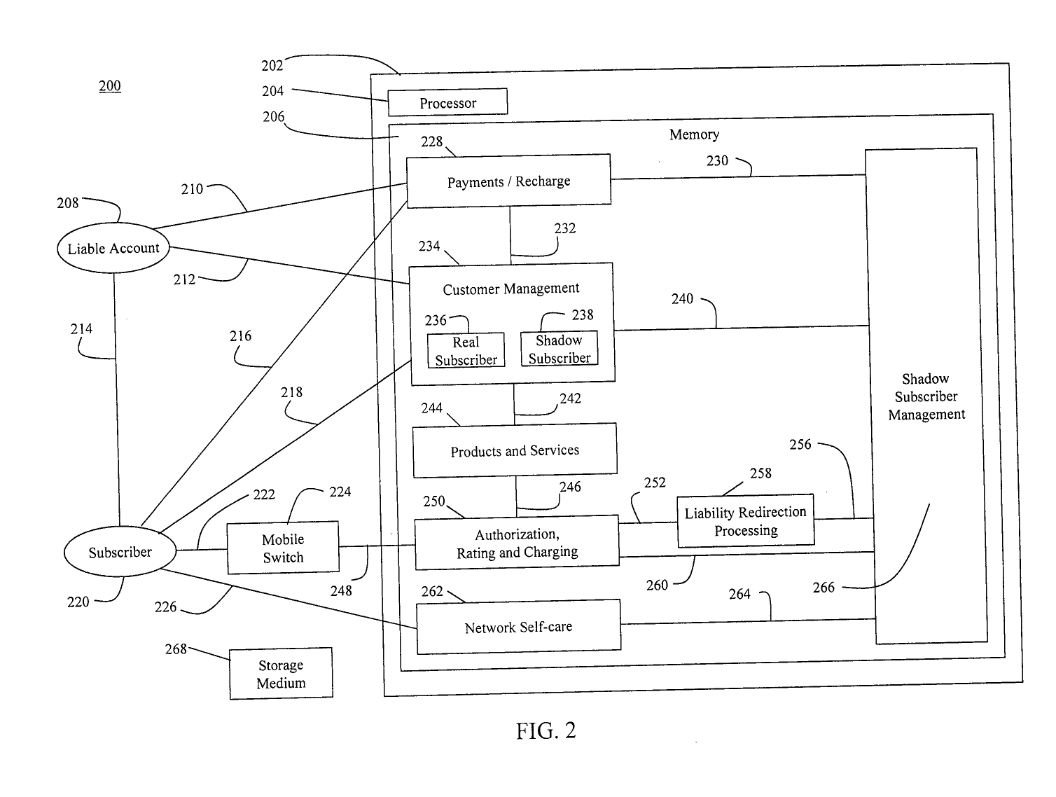

FIG. 2 is a block diagram of a communication system 200 that enables provision of a service for a subscriber that is linked to a plurality of accounts. System 200 includes a mobile switch 224 and a processing system 202.

Mobile switch 224 is a switch for facilitating a service, for example a voice call or a data service, over a network (not shown). Mobile switch 224 operates in accordance with a communication that it receives from processing system 202 in a manner that affects the provision of the service. For example, in response to the communication, mobile switch 224 may allow the provision of the service, deny the service, or in some other way modify the provision of the service.

Processing system 202 includes a processor 204 and a memory 206. Processor 204 is configured of logic circuitry that responds to and executes instructions. Memory 206 contains instructions that are readable by processor 204 and cause processor 204 to perform actions of a Payments/Recharge module 228, a Customer Management module 234, a module that represents products and services, i.e., Products and Services 244, and Authorization, Ratings and Charging module 250, a Network Self-care module 262, a Liability Redirection Processing module 258, and a Shadow Subscriber Management module 266. The term “module” is used herein to denote a functional operation that may be embodied either as a stand-alone component or as an integrated configuration of a plurality of sub-ordinate components.

In Customer Management module 234, processor 200 maintains data representing a real subscriber 236 and a shadow subscriber 238.

A subscriber 220 is a person that is consumer of network services. For purposes of illustration in this document, subscriber 220 is in possession of a mobile phone to accomplish this. Subscriber 220 places calls that are evaluated by processing system 202.

A liable account 208 is an entity accepting financial responsibility for at least a portion of charges from subscriber 220. Subscriber 220 can have a billing relationship with more than one liable account, but for simplicity of illustration, only one liable account, i.e., liable account 208, is shown here. Conversely, liable account 208 can have a billing relationship with more than one subscriber, but similarly, for simplicity, only one, i.e., subscriber 220, is shown here.

Customer Management module 234 encompasses the representation of liable account 208 and subscriber 220 information within processing system 202, as well as Products and Services 244 to which liable account 208 and subscriber 220 have subscribed. Subscriber 220 is represented in Customer Management module 234 by its primary entity, i.e., real subscriber 236, and by shadow subscriber 238, each of which reflects a billing relationship between subscriber 220 and liable account 208.

Products and Services 244 represents services that subscriber 220, via real subscriber 236 and shadow subscriber 238, receives over the network through his cell phone, as well as the pricing plans for those services.

Each of real subscriber 236 and shadow subscriber 238 has a pricing plan, i.e., account terms, (not shown in FIG. 2, but similar to pricing plans 125 and 140 shown in FIG. 1). Real subscriber 236's pricing plan may provide for charging a first rate for a network communication service, and shadow subscriber 238's pricing plan may provide for charging a second rate for the network communication service.

Shadow Subscriber Management module 266 manages storage, validation, and evaluation of shadow subscriber 238 information, a billing relationship between subscriber 220 and shadow subscriber 238, and a billing relationship between liable account 208 and shadow subscriber 238.

Mobile switch 224 facilitates a call made from the cell phone of subscriber 220 and seeks pre-authorization from Authorization, Ratings and Charging module 250.

Authorization, Ratings and Charging module 250 consults with Shadow Subscriber Management module 266 to understand the billing relationship present between real subscriber 236 and shadow subscriber 238. Authorization, Ratings and Charging module 250 interacts with Liability Redirection Processing module 258 to evaluate whether the call should be processed in the context of real subscriber 236 or shadow subscriber 238. Authorization, Ratings and Charging module 250 queries Products and Services 244 to understand the pricing plan via which the call should be rated and charged.

Liability Redirection Processing module 258 facilitates the evaluation of liability redirection rules that determine whether a call is guided to real subscriber 236 or to shadow subscriber 238, and, if necessary, the transfer of processing of the call from the context of real subscribers 236 to the context of shadow subscriber 238.

Network Self-care module 262 allows subscriber 220, via his cell phone, to set liability redirection override information in Shadow Subscriber Management module 266. Liability redirection override allows subscriber 220 to bypass redirection rule processing and indicate that liability is unconditionally redirected to a specific shadow subscriber, e.g., shadow subscriber 238, regardless of the nature of the network event.

Payments/Recharge module 228 allows for liable account 208 to make a payment on an invoice that reflects the charges that were redirected to it by the subscriber 220 via shadow subscriber 238. Payments/Recharge module 228 also allows for either subscriber 220 or liable account 208 to recharge prepaid balances of shadow subscriber 238. The balances on shadow subscriber 238 can be recharged via an interactive voice response (IVR) interaction initiated by subscriber 220. Network Self-care module 262 detects whether subscriber 220 has shadow subscribers 238 in addition to its real subscriber 236. If subscriber 220 has a plurality of shadow subscribers, subscriber 220 is prompted to identify which of the plurality that subscriber 220 would like to recharge.

Before subscriber 220's use of shadow subscriber 238, subscriber 220 establishes a presence, via an interaction 218, as real subscriber 236. Products and Services 244 that real subscriber 236 receives are established via an interaction 242.

A person-to-person agreement between liable account 208 and subscriber 220, via an interaction 214, is reached to establish a billing relationship whereby liable account 208 accepts liability for a subset of the charges incurred by subscriber 220. This billing relationship is represented via (a) an interaction 212 where, as a result, shadow subscriber 238 is created, (b) interaction 242 where shadow subscriber 238's distinct set of Products and Services 244 is selected, and (c) an interaction 240 where the billing relationship between real subscriber 236 and shadow subscriber 238 is maintained.

The billing relationship between real subscriber 236 and shadow subscriber 238 is given a distinct name to distinguish it from other billing relationships established between other entities. The billing relationship is represented by a liability redirection rule that indicates the conditions under which charges should be redirected from real subscriber 236 to shadow subscriber 238.

Subscriber 220 has the option to override the liability redirection rules associated with its billing relationship to shadow subscriber 238 and unconditionally redirect all liability to shadow subscriber 238. This is accomplished by interaction 226 between subscriber 220 and Network Self-care module 262. Liable account 208 can, however, as the entity accepting financial responsibility, indicate that subscriber 220 is not allowed to manually override liability redirection to shadow subscriber 238.

At this point all relationships have been set up to enable the redirection of a call to shadow subscriber 238.

Via an interaction 222, subscriber 220 places a call that is handled by mobile switch 224. Mobile switch 224, via a synchronous interaction, i.e., an interaction 248, asks Authorization, Ratings and Charging module 250 for pre-authorization of the network event. The pre-authorization insures that some financially-responsible party will be able to pay for the network services consumed.

Authorization, Ratings and Charging module 250 (a) via an interaction 260, obtains information about real subscriber 236 and shadow subscriber 238 from Shadow Subscriber Management module 266, and (b) via an interaction 252, evaluates liability redirection rules from Liability Redirection Processing module 258, which (c), via an interaction 256, redirects the call, to shadow subscriber 238. An interaction 246 provides, to Authorization, Ratings and Charging module 250, information related to Products and Services 244. Upon successful processing against shadow subscriber 238, a yes/no communication is provided back to mobile switch 224, as the synchronous response for interaction 248, that will then either allow or deny the call depending upon whether the communication is a ‘yes’ or a ‘no’, respectively. For example, a decision of whether to authorization of a call that would be charged to shadow subscriber 238 may be based on whether the charge would exceed shadow subscriber 238's spending limit.

Thus, in review, processing system 202 receives a notification of an event, via interaction 248, concerning a network communication service involving subscriber 220, where subscriber 220 is linked to real subscriber 236, i.e., a first account having first account terms, and shadow subscriber 238, i.e., a second account having second account terms. Processing system 202 makes a decision of whether to handle the network communication service in accordance with subscriber 220 being linked to real subscriber 236 or in accordance with subscriber 238 being linked to shadow subscriber 238. Thereafter, processing system 202 issues a communication via interaction 248 to mobile switch 224, i.e., a device in the network, to facilitate the network communication service, pursuant to the decision.

Processing system 202 (i) charges real subscriber 236 for the network communication service pursuant to account terms of real subscriber 236, if the decision is to handle the network communication service in accordance with subscriber 220 being linked to real subscriber 236, or (ii) charges shadow subscriber 238 for the network communication service pursuant to account terms of shadow subscriber 238, if the decision is to handle the network communication service in accordance with subscriber 220 being linked to shadow subscriber 238.

Processing system 202 will bill subscriber 220 for charges to real subscriber 236, and will bill liable account 208 for charges to shadow subscriber 238.

The network communication service can be any of a plurality of services, for example, a voice call or a data service. The decision of how to handle the network communication service may consider the nature of the service being provided, or that the network communication service is a particular service. For example, processing system 202 may decide to either (i) handle the network communication service in accordance with subscriber 220 being linked to real subscriber 236, if the network communication service is a voice call, or (ii) handle the network communication service in accordance with subscriber 220 being linked to shadow subscriber 238, if the network communication service is a data service.

Subscriber 220, through his link to either or both of real subscriber 236 or shadow subscriber 238, and more particularly the respective pricing plans for real subscriber 236 and shadow subscriber 238, may be a member of a particular pricing plan such as a calling circle or an intra-hierarchy discounting plan. The decision of how to handle the network communication service may consider whether subscriber 220 is a member of such a pricing plan. For example, assuming real subscriber 236 has a pricing plan that provides for intra-hierarchy discounting, the decision may be to handle the network communication service in accordance with subscriber 220 being linked to real subscriber 236 based, at least in part, on subscriber 220's membership in the intra-hierarchy discounting plan, via real subscriber 236. In another example, if the network communication service involves a call with a party that is a member of a calling circle, and if shadow subscriber 238's pricing plan provides for membership in the calling circle, the decision may be to handle the call in accordance with subscriber 220 being linked to shadow subscriber 238.

Subscriber 220, via his cell phone, can access Network Self-care module 262 via an interaction 226 to set a liability redirection override to shadow subscriber 238, which is then set in Shadow Subscriber Management module 266 via an interaction 264. For example, Network Self-care module 262 can receive an instruction from subscriber 220 that mandates a handling of all service in accordance with subscriber 220 being linked to shadow subscriber 238, and in Shadow Subscriber Management module 266, the decision of how to handle a service would operate in accordance with the instruction.

Prepaid balances of shadow subscriber 238 can be replenished by Payments/Recharge module 228 being triggered by subscriber 220 via an interaction 216 or by liable account 208 via an interaction 210. In either case, Payments/Recharge 228 obtains details from Shadow Subscriber Management module 266 via an interaction 230 and applies funds to shadow subscriber 238 via an interaction 232.

Although processing system 202 is described herein as having the instructions installed into memory 206, the instructions can be tangibly embodied on an external computer-readable storage medium 268 for subsequent loading into memory 206. Storage medium 268 can be any conventional storage medium, including, but not limited to, a floppy disk, a compact disk, a magnetic tape, a read only memory, or an optical storage medium. The instructions could also be embodied in a random access memory (not shown), or other type of electronic storage (not shown), located on a remote storage system and coupled to memory 206.

Processing system 202 is shown herein as being implemented with a single processor 202 and a single memory 206. However, processing system 202 can be implemented as a distributed system configured with a plurality of processors and a plurality of memories. Moreover, although components of processing system 202 are described herein as being installed in memory 206, and therefore being implemented in software, they could be implemented in any of hardware, firmware, software, or a combination thereof.

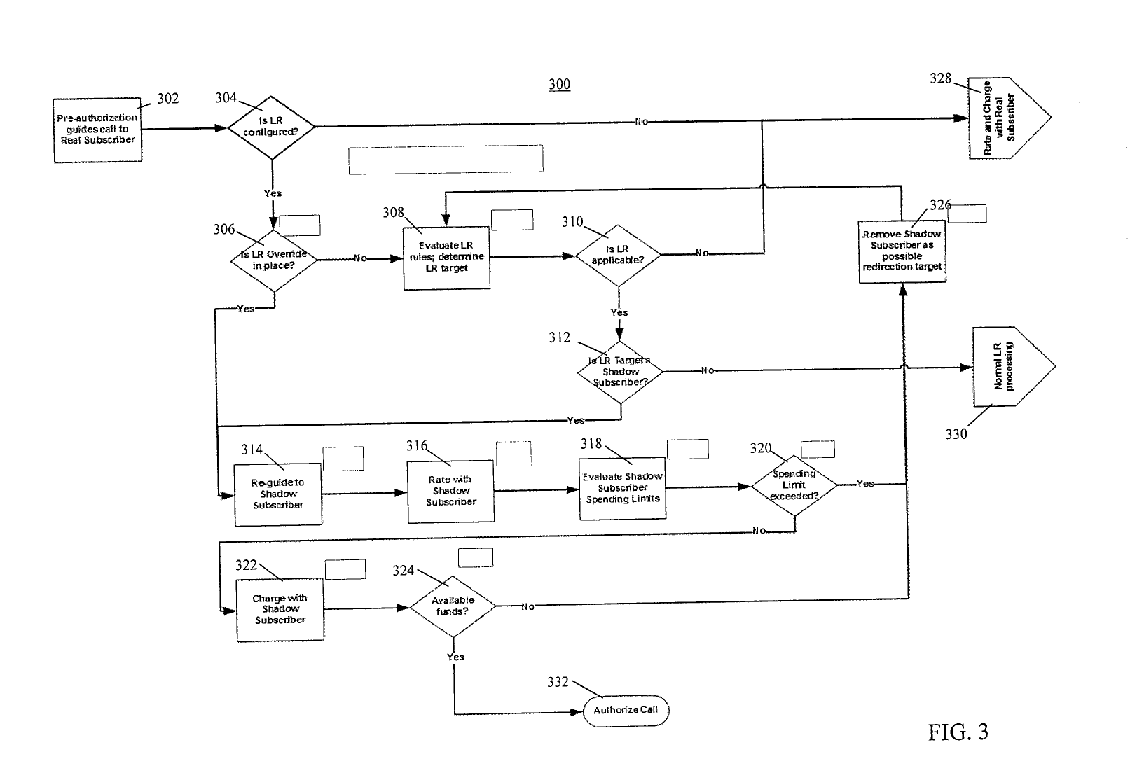

FIG. 3 is a flowchart of a pre-authorization process, referred to herein as method 300, performed by processing system 202. Accordingly, the following description of FIG. 3 refers to several components shown in FIG. 2.

In step 302, subscriber 220 is making a call, and the call has been guided to real subscriber 236 by Authorization, Ratings and Charging module 250. From step 302, method 300 progresses to step 304.

In step 304, Liability Redirection Processing module 258 determines whether any liability redirection (LR) is configured for real subscriber 304. If “no”, then method 300 advances to step 328. If “yes”, then method 300 progresses to step 306.

In step 306, Liability Redirection Processing module 258 checks whether real subscriber 236 has specified a liability redirection override to shadow subscriber 238. If “yes”, then method 300 advances to step 314. If “no”, then method 300 progresses to step 308.

In step 308, Liability Redirection Processing module 258 evaluates liability redirection rules and determines a liability redirection target. From step 308, method 300 progresses to step 310.

In step 310, Liability Redirection Processing module 258 compares the attributes of the call (e.g., time of day, type of call, destination number) against the liability redirection rules configured for real subscriber 236. If no matching rules are found, then method 300 advances to step 328. If at least one matching rule is found, then method 300 progresses to step 312. If more than one matching rule is found, the rule with the closest and most significant matching criteria is selected for processing in step 312.

In step 312, Shadow Subscriber Management module 266 determines whether the liability redirection target, i.e., the entity to accept liability for the call being placed, is a shadow subscriber. If “no”, then method 300 advances to step 330. If “yes”, then method 300 progresses to step 314. For example, if the selected rule (from step 310) simply points to an account, i.e., a non-shadow subscriber scenario, then method 300 advances to step 330.

In step 314 Shadow Subscriber Management module 266 re-guides the call to shadow subscriber 236 tied to either (a) the liability redirection override discovered at step 306, or (b) the liability redirection rule identified at steps 310 and 312, thereby transforming the context of the evaluation of the call from that of real subscriber 236 to that of shadow subscriber 238. From step 314, method 300 progresses to step 316.

In step 316, Authorization, Ratings and Charging module 250 rates the call in the context of the applicable pricing plans of shadow subscriber 238. Referring back to FIG. 1, it might be the case that the pricing terms of the “Best Voice” offer, i.e., pricing plan 125, have been specifically negotiated between Acme and the service provider, and part of the condition is that they not be offered for personal use. Pricing plan 125 might, for example, include free calling to all points in North America. Pricing plan 140, on the other hand, might for example rate calls to North American countries outside the US at $0.05/min. Rating the call from the context of the shadow subscriber insures that this call is rated at $0.05/min as opposed to being rated as free. From step 316, method 300 progresses to step 318.

In step 318, Authorization, Ratings and Charging module 250, based on the rated amount determined in step 316, evaluates the amount against the spending limit of shadow subscriber 238. From step 318, method 300 progresses to step 320.

In step 320, assuming that liable account 208 has chosen to limit its liability to a set amount per billing cycle, then Authorization, Ratings and Charging module 250 compares (a) the amount consumed to date by shadow subscriber 238, plus the rated amount for the call currently being processed against (b) the set spending limit. If the spending limit is exceeded, then method 300 advances to step 326. If the spending limit is not exceeded, then method 300 progresses to step 322. Also, if liable account 208 has not chosen to limit its liability to a set amount per billing cycle, then there is no set spending limit, and as such, method 300 progresses to step 322.

In step 322 Authorization, Ratings and Charging module 250 charges shadow subscriber 238 balances based on the rated amount determined in step 316. From step 322, method 300 progresses to step 324.

In step 324, assuming that the spending limit evaluated in step 320 is being consumed from an available balance, the available balance must have available funds to cover the rated amount of the charge determined in 316. Accordingly, Authorization, Ratings and Charging module 250 determines whether there is a sufficient available balance to fund the call. If “no”, then method 300 progresses to step 326. If “yes”, then the charge amount is counted against the spending limit and deducted from the available balance, and method 300 advances to step 332.

In step 326, regardless of whether method 300 reached here from step 320 or step 324, for one reason or another, the call cannot be funded by shadow subscriber 238. The liability redirection rule that just failed to fund the event is removed from consideration, and method 300 loops back to step 308, where the evaluation process further considers liability redirection rules for real subscriber 236.

In step 328, normal call processing continues in the context of real subscriber 236 without liability redirection.

In step 330, liability redirection processing continues in the context of real subscriber 236.

In step 332, Authorization, Ratings and Charging module 250 sends a communication to mobile switch 224 indicating that the call is authorized.

Shadow subscriber are treated the same as real subscribers in nearly all facets of the system. This allows processing to capitalize on implementation already established for run-of-the-mill subscriber call pre-authorization processing.

The main technical benefit of the shadow subscriber solution is that by providing a technique, via software implementation, to recast the pre-authorization evaluation of an event into the context of the real subscriber or any of its shadow subscribers, it allows for that complex relationship to exist in only one place and be applicable and accessible to all systems. Without this capability, additional hardware and data synchronization would be necessary, increasing deployment complexity and system cost.

Via a single device, e.g., a cell phone, a person can have billing relationships with multiple financially accountable parties.

The relationship of real subscriber 236 with multiple shadow subscribers such as shadow subscriber 238 allows subscriber 220 to have a multi-dimensional footprint in processing system 202. Real subscriber 236 and shadow subscriber 238 memberships in multiple calling circles and account hierarchies allow subscriber 220 to garner benefits for calling circle and intra-hierarchy discounting that would not be possible with just a single representation of subscriber 220 in the system.

Processing system 202 gives the service provider the power to model the wide variety of complicated billing relationships that its customers demand. Paying parties have the flexibility to accept charges in the context of pricing plans that they select, rather than remaining at the mercy of the plan(s) selected by the consuming party. Paying parties have the opportunity to limit the amount of liability they want to accept in any given period, putting them in control of their spending. Redirection, evaluation against the payer's pricing plans, and enforcement of spending limits, is all evaluated in real-time during call pre-authorization, so the service provider can offer all this capability to its prepaid subscribers, whereas historically this kind of complexity was only available in a postpaid environment. End-users can use the manual override feature as a means to keep charges for calls related to the different parts of their life (personal, day job, entrepreneurial undertaking, etc) separated in a nice and tidy fashion.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

TABLE 1
Definitions

| Term | Definition |
|---|---|
| Account | An entity that represents a customer of an operator. An account |
| | can be billable (for example, the liable party that owns the accounts |
| | receivable) or non-billable. An account contains the subscriber |
| | profile details and can have associated subscribers and offers. An |
| | account can have one or more child accounts (organized in a |
| | hierarchy), as well as one or more subscribers and offers. An |
| | account can have zero or one account bundle. Accounts can have |
| | real-time balances and accumulators. |
| Balance | A balance is a collection of funds of a similar unit type. Balances |
| | can be either (1) running (real-time authorization) balances or (2) |
| | financial (accounts receivable) balances. A balance is a |
| | representation of either a monetary or a non-monetary (units-based) |
| | amount. A balance can be either postpaid or prepaid. A postpaid |
| | balance can signify a unit amount, a monetary credit, or a spending |
| | limit, or the total amount due; all of which are incremented based |
| | upon user consumption activity. A real-time prepaid balance can |
| | represent the reserved holding of funds or units drawn from when a |
| | user consumes services. |
| Calling Circle | A group that subscribers can join to secure special/differentiated |
| | rates and discounts for intra-group usage activity. |
| Guiding | The process of determining the charging party for the consumed |
| | usage. |
| IVR | Interactive Voice Response (IVR) is an interactive technology that |
| | allows a computer to detect voice and keypad inputs allowing |
| | customers to service their own enquiries by following the |
| | instructions. |
| Liability Redirection | A feature that allows charges to be paid for by an entity (account or |
| | shadow subscriber) other than the entity that uses the services. |
| | Liability redirection involves configurable charge redirection to |
| | liable parties as follows: |
| | Account to account |
| | Subscriber to account |
| | Subscriber to shadow subscriber |
| Liable Account | Account that is liable for payments for services used by the owning |
| | account and/or subscribers. |
| Postpaid | A general description of the financial arrangement between the |
| | operator and the end-user, whereby the user accrues charges over |
| | the course of a billing period (typically a month), and the operator |
| | bills the end-user for those charges after the fact. In this model, the |
| | operator is in essence extending credit to the end-user. |
| Pre-authorization | The process by which the network requests, in advance of actually |
| | providing a network service to a consumer, authorization from an |
| | authorizing entity which is trusted to insure that the network |
| | service about to be consumed can be paid for by some financially |
| | responsible party. Access to the network service is either granted |
| | or denied based on the response from the authorizing entity. |
| Prepaid | A general description of the financial arrangement between the |
| | operator and the end-user, whereby the end-user provides funds up |
| | front, and then accrued charges are debited against those funds |
| | until exhausted, at which point in time service will be denied until |
| | additional funds are provided in advance. |
| Real-time | Describes an activity or transaction that occurs during the rating |
| | and/or charging process, as opposed to waiting until the end of a |
| | cycle (bill time). Note that the “real-time” rating and/or charging |
| | process takes place, in most cases, during the actual duration of the |
| | usage event that is being rated and/or charged. |
| Recharge | Recharging is a process by which a subscriber adds time, units, or |
| | monetary value for services to running balances. This can also |
| | extend or change an expiration date for a running balance. |
| | Recharging is done with physical or electronic recharge vouchers. |
| | Recharges are the primary way that money is received into prepaid |
| | operations. |
| Redirection Rules | Rules that are used to determine if a given network event (i.e. call) |
| | should be redirected to an alternative party for rating and charging. |
| | Rules are evaluated based on the characteristics of the network |
| | event, for example, the type of event, the date, day, and/or time on |
| | which it occurred, and the target, i.e. the called number, of the |
| | network event. |
| Subscriber | A subscriber is at a specific service-delivery point for a product or |
| | service being used by an account. Examples: a telephone line, a |
| | login account for an online service, an end point in a leased line |
| | network. |
| Shadow Subscriber | A subscriber whose charges are paid by an account other than its |
| | own. A shadow subscriber is a virtual subscriber. The shadow- |
| | subscriber feature allows certain charge liabilities to be redirected |
| | from one account to another. The shadow subscriber is liable for |
| | those redirected charges. For example, if an employee must pay |
| | for calls outside of business hours, then charges for calls made after |
| | work can be redirected to a personal account. See also liability |
| | redirection and liable account. |
| Synchronous | A synchronous interaction between two systems is such that the |
| | party making the request will suspend processing and wait for a |
| | response to the request. This is in contrast to asynchronous |
| | interaction, where the requesting party will fire off the request, go |
| | about its business, and process the response, once received, in an |
| | interrupt-driven manner. |

What is claimed is:

1. A method comprising:
receiving a notification of an event concerning a network communication service involving a subscriber, wherein said subscriber is linked to a first account having first account terms, and a second account having second account terms;
making a decision of whether to handle said network communication service in accordance with said subscriber being linked to said first account or in accordance with said subscriber being linked to said second account; and
issuing a communication to a device to facilitate said network communication service, pursuant to said decision.

2. The method of claim 1, further comprising either:
charging said first account for said network communication service pursuant to said first account terms, if said decision is to handle said network communication service in accordance with said subscriber being linked to said first account, or
charging said second account for said network communication service pursuant to said second account terms, if said decision is to handle said network communication service in accordance with said subscriber being linked to said second account.

3. The method of claim 2,
wherein said network communication service can be either of a first service or a second service, and
wherein said decision is to:
(a) handle said network communication service in accordance with said subscriber being linked to said first account, if said network communication service is said first service; or
(b) handle said network communication service in accordance with said subscriber being linked to said second account, if said network communication service is said second service.

4. The method of claim 2,
wherein said first account terms provide for charging a first rate for said network communication service, and
wherein said second account terms provide for charging a second rate for said network communication service.

5. The method of claim 1, further comprising:
billing a first entity for said first account; and
billing a second entity for said second account.

6. The method of claim 1,
wherein said first account terms include a spending limit,
wherein said network communication service is subject to a charge, and
wherein, if said decision is to handle said network communication service in accordance with said subscriber being linked to said first account, said communication (a) authorizes said network communication service, if said charge does not exceed said spending limit, or (b) does not authorize said network communication service, if said charge exceeds said limit.

7. The method of claim 1,
wherein said making said decision comprises considering whether said subscriber is a member of a pricing plan via said first account; and
wherein said decision is to handle said network communication service in accordance with said subscriber being linked to said first account, if said subscriber is a member of said pricing plan via said first account.

8. The method of claim 7, wherein said pricing plan is of a type selected from the group consisting of (a) a calling circle, and (b) an intra-hierarchy discounting plan.

9. The method of claim 1,
wherein said network communication service involves a call with a party that is a member of a calling circle,
wherein said making said decision comprises considering whether said subscriber is a member of said calling circle via said first account; and
wherein said decision is to handle said network communication service in accordance with said subscriber being linked to said first account, if said subscriber is a member of said calling circle via said first account.

10. The method of claim 1, also comprising:
prior to said receiving, receiving an instruction that mandates a handling of said network communication service in accordance with said subscriber being linked to said first account,
wherein said making said decision operates in accordance with said instruction.

11. The method of claim 1,
wherein said making said decision comprises considering whether said network communication service is a particular service; and
wherein said decision is to handle said network communication service in accordance with said subscriber being linked to said first account, if said network communication service is said particular service.

12. A system comprising:
a processor; and
a memory that contains instructions that are readable by said processor and control said processor to perform actions of:
receiving a notification of an event concerning a network communication service involving a subscriber, wherein said subscriber is linked to a first account having first account terms, and a second account having second account terms;
making a decision of whether to handle said network communication service in accordance with said subscriber being linked to said first account or in accordance with said subscriber being linked to said second account; and
issuing a communication to a device to facilitate said network communication service, pursuant to said decision.

13. The system of claim 12, wherein said actions further include either:
charging said first account for said network communication service pursuant to said first account terms, if said decision is to handle said network communication service in accordance with said subscriber being linked to said first account, or
charging said second account for said network communication service pursuant to said second account terms, if said decision is to handle said network communication service in accordance with said subscriber being linked to said second account.

14. The system of claim 13,
wherein said network communication service can be either of a first service or a second service, and
wherein said decision is to:
(a) handle said network communication service in accordance with said subscriber being linked to said first account, if said network communication service is said first service; or
(b) handle said network communication service in accordance with said subscriber being linked to said second account, if said network communication service is said second service.

15. The system of claim 13,
wherein said first account terms provide for charging a first rate for said network communication service, and
wherein said second account terms provide for charging a second rate for said network communication service.

16. The system of claim 12, wherein said actions further include:
billing a first entity for said first account; and
billing a second entity for said second account.

17. The system of claim 12,
wherein said first account terms include a spending limit,
wherein said network communication service is subject to a charge, and
wherein, if said decision is to handle said network communication service in accordance with said subscriber being linked to said first account, said communication (a) authorizes said network communication service, if said charge does not exceed said spending limit, or (b) does not authorize said network communication service, if said charge exceeds said limit.

18. The system of claim 12,
wherein said making said decision comprises considering whether said subscriber is a member of a pricing plan via said first account; and
wherein said decision is to handle said network communication service in accordance with said subscriber being linked to said first account, if said subscriber is a member of said pricing plan via said first account.

19. The system of claim 18, wherein said pricing plan is of a type selected from the group consisting of (a) a calling circle, and (b) an intra-hierarchy discounting plan.

20. The system of claim 12,
wherein said network communication service involves a call with a party that is a member of a calling circle,
wherein said making said decision comprises considering whether said subscriber is a member of said calling circle via said first account; and
wherein said decision is to handle said network communication service in accordance with said subscriber being linked to said first account, if said subscriber is a member of said calling circle via said first account.

21. The system of claim 12, wherein said actions further include:
prior to said receiving, receiving an instruction that mandates a handling of said network communication service in accordance with said subscriber being linked to said first account,
wherein said making said decision operates in accordance with said instruction.

22. The system of claim 12,
wherein said making said decision comprises considering whether said network communication service is a particular service; and
wherein said decision is to handle said network communication service in accordance with said subscriber being linked to said first account, if said network communication service is said particular service.

23. A storage medium comprising instructions that are readable by a processor to control said processor to perform actions of:
receiving a notification of an event concerning a network communication service involving a subscriber, wherein said subscriber is linked to a first account having first account terms, and a second account having second account terms;
making a decision of whether to handle said network communication service in accordance with said subscriber being linked to said first account or in accordance with said subscriber being linked to said second account; and
issuing a communication to a device to facilitate said network communication service, pursuant to said decision.

24. The storage medium of claim 23, wherein said actions further include either:
charging said first account for said network communication service pursuant to said first account terms, if said decision is to handle said network communication service in accordance with said subscriber being linked to said first account, or
charging said second account for said network communication service pursuant to said second account terms, if said decision is to handle said network communication service in accordance with said subscriber being linked to said second account.

25. The storage medium of claim 24,
wherein said network communication service can be either of a first service or a second service, and
wherein said decision is to:
(a) handle said network communication service in accordance with said subscriber being linked to said first account, if said network communication service is said first service; or
(b) handle said network communication service in accordance with said subscriber being linked to said second account, if said network communication service is said second service.

26. The storage medium of claim 24,
wherein said first account terms provide for charging a first rate for said network communication service, and
wherein said second account terms provide for charging a second rate for said network communication service.

27. The storage medium of claim 23, wherein said actions further include:
billing a first entity for said first account; and
billing a second entity for said second account.

28. The storage medium of claim 23,
wherein said first account terms include a spending limit,
wherein said network communication service is subject to a charge, and
wherein, if said decision is to handle said network communication service in accordance with said subscriber being linked to said first account, said communication (a) authorizes said network communication service, if said charge does not exceed said spending limit, or (b) does not authorize said network communication service, if said charge exceeds said limit.

29. The storage medium of claim 23,
wherein said making said decision comprises considering whether said subscriber is a member of a pricing plan via said first account; and
wherein said decision is to handle said network communication service in accordance with said subscriber being linked to said first account, if said subscriber is a member of said pricing plan via said first account.

30. The storage medium of claim 29, wherein said pricing plan is of a type selected from the group consisting of (a) a calling circle, and (b) an intra-hierarchy discounting plan.

31. The storage medium of claim 23,
wherein said network communication service involves a call with a party that is a member of a calling circle,
wherein said making said decision comprises considering whether said subscriber is a member of said calling circle via said first account; and
wherein said decision is to handle said network communication service in accordance with said subscriber being linked to said first account, if said subscriber is a member of said calling circle via said first account.

32. The storage medium of claim 23, wherein said actions further include:
prior to said receiving, receiving an instruction that mandates a handling of said network communication service in accordance with said subscriber being linked to said first account,
wherein said making said decision operates in accordance with said instruction.

33. The storage medium of claim 23,
wherein said making said decision comprises considering whether said network communication service is a particular service; and
wherein said decision is to handle said network communication service in accordance with said subscriber being linked to said first account, if said network communication service is said particular service.
